(19) United States
(12) Patent Application Publication
(10) Pub. No.: US 2002/0188543 A1
(43) Pub. Date: Dec. 12, 2002

(54) System and method for formating a portfolio report of fixed income securities

(76) Inventors: Adam Wizon, New Providence, NJ (US); Joseph M. Kochansky, New York, NY (US)

Correspondence Address: CUMMINGS AND LOCKWOOD, GRANITE SQUARE, 700 STATE STREET, P O BOX 1960, NEW HAVEN, CT, 06509-1960, US

(21) Appl. No.: 10/167,353

(22) Filed: Jun. 11, 2002

Related U.S. Application Data
(60) Provisional application No. 60/297,519, filed on Jun. 12, 2001.

(51) Int. Cl. G06F 17/60

(52) U.S. Cl. 705/36

(57) ABSTRACT

A system is disclosed for formatting a computer generated report for a portfolio of fixed income securities. The system allows a user to select a portfolio of fixed income securities stored in a portfolio database, wherein each fixed income security in the portfolio has a set of attributes associated therewith. The system also allows a user to select a subset of attributes from the set of attributes for presentation in a report for the selected portfolio, and to selectively group the fixed income securities in the portfolio for presentation in the report.

### CROSS-REFERENCE TO RELATED APPLICATIONS

The subject application claims the benefit of priority to U.S. Provisional Patent Application Serial No. 60/297,519 filed Jun. 12, 2001, the disclosure of which is incorporated herein by reference in its entirety.

### BACKGROUND OF THE INVENTION

1. Field of the Invention

The subject invention is directed to financial portfolio management, and more particularly, to a system and method for formatting a computer generated report presenting a portfolio of fixed income securities in a desired manner.

2. Background of the Related Art

An investment portfolio of fixed income securities can include a broad range of asset classes including, for example, Treasury bonds, agency and municipal bonds, futures, options, interest rate swaps, OTC derivatives, mortgage backed securities, and many others. Each of these assets have associated therewith certain attributes including asset specific attributes, such as, for example, maturity, market price, coupon and nominal yield, and risk related attributes, such as, for example, duration, spread duration and convexity.

Portfolio mangers traditionally generate reports presenting the assets in a portfolio in a manner that focuses on particular financial attributes, depending upon the economic factors at play at a particular point in time. Because the economic landscape is in a continuous state of flux, the attributes upon which most diversified portfolio reports focus are also continuously changing.

Accordingly, it would be beneficial to provide a computer-based system that enables portfolio managers and other interested parties to selectively define the format of a portfolio report in real-time so as to present financial information in a useful and efficient manner.

### SUMMARY OF THE INVENTION

The subject invention is directed to a new and useful system for formatting a computer generated report for a portfolio of fixed income securities. The system includes means for selecting a portfolio of fixed income securities stored in a portfolio database. Preferably, each fixed income security in a selected portfolio belongs to an asset sector and has a set of attributes associated therewith. The asset sectors include, among others, Treasury bonds, derivatives and mortgage-backed securities.

The attributes associated with each security include identification information such as, for example, security description and asset identifier, as well as financial information such as, for example, current face value, current coupon, accrued interest, modified duration, discount margin, option adjusted spread (OAS), static spread to a curve. Those skilled in the art will readily appreciate that many other statistics or risk based measures may be made available for reporting.

The system of the subject invention further includes means for selecting a subset of attributes from the set of attributes for presentation in a report for the selected portfolio of fixed income securities. The system of the subject invention also includes means for grouping the fixed income securities in the selected portfolio according to a user-selected characteristic for presentation in the report. For example, the securities in the selected portfolio could be grouped according to asset sector. Other characteristics for grouping the securities can include asset-based or risk-based classification schemes.

Preferably, the means for selecting a subset of attributes includes a graphical user interface presenting a list of available attributes. The means for selecting a subset of attributes preferably includes means for selectively adding attributes to and removing attributes from the subset of attributes. Preferably, when the fixed income securities in a selected portfolio are grouped by asset sector, the securities in each asset sector are further sorted for presentation in a report based upon a particular attribute from the subset. For example, the fixed income securities in each asset sector may be sorted for presentation based upon security description.

The subject invention is also directed to a method of formatting a computer generated report for a portfolio of fixed income securities. The method includes the step of selecting a portfolio of fixed income securities stored in a portfolio database, wherein each fixed income security in the portfolio belongs to an asset sector and has a set of attributes associated therewith. The method further includes the steps of selecting a subset of attributes from the set of attributes for presentation in a report for the selected portfolio of fixed income securities. The step of selecting a subset of attributes preferably includes the step of selectively adding attributes to and removing attributes from the subset of attributes. Preferably, the method also includes the step of generating a report for the selected portfolio of fixed income securities based upon the selected subset of attributes.

In an embodiment of the subject invention, the method further includes the step of selectively grouping the fixed income securities in the selected portfolio according to asset sector for presentation in the report. Preferably, such a method includes the step of generating a report for the selected portfolio of fixed income securities based upon asset sector.

These and other aspects of the system and method of the subject invention will become more readily apparent to those having ordinary skill in the art from the following detailed description of the invention taken in conjunction with the drawings described herein below.

### BRIEF DESCRIPTION OF THE DRAWINGS

So that those having ordinary skill in the art to which the subject invention pertains will more readily understand how to make and use the system of the subject invention, embodiments thereof will be described in detail hereinbelow with reference to the drawings, wherein:

FIG. 1 is a schematic representation of the core functional components of the computer-based portfolio reporting system of the subject invention;

FIG. 2 is an illustration of a graphical user interface which facilitates the selection of a portfolio of fixed income securities from a portfolio database;

FIG. 3 is an illustration of a graphical user interface which facilitates the specification of a portfolio report format, including the grouping of fixed income securities by asset sector;

FIG. 4 is an illustration of a display screen presenting an unsectored portfolio of fixed income securities; and

FIG. 5 is an illustration of a display screen presenting the portfolio of fixed securities of FIG. 4 in a sectored format.

### DETAILED DESCRIPTION OF THE PREFERRED EMBODIMENTS

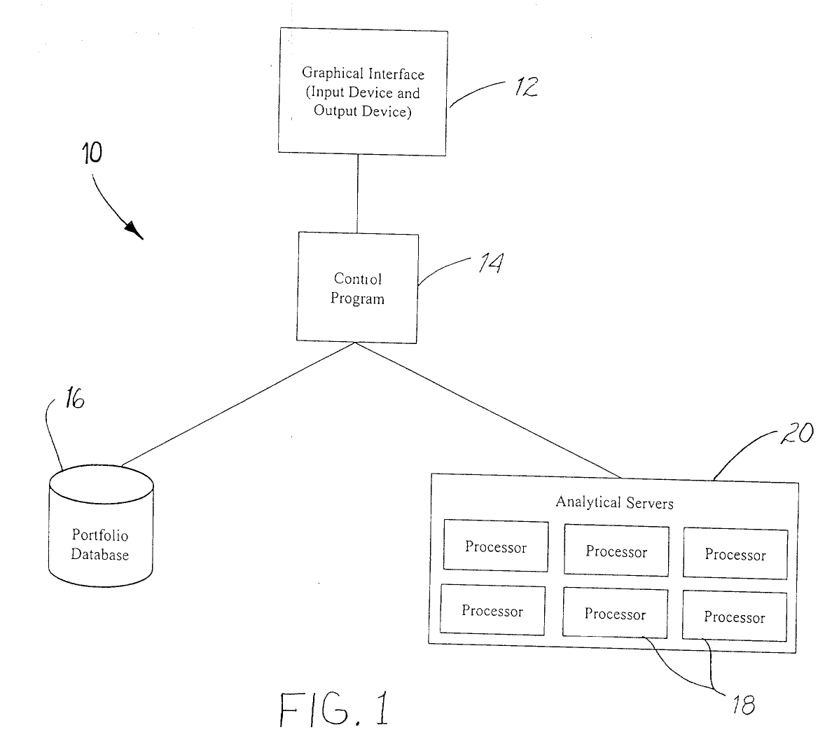

Referring now to the drawings wherein like reference numerals identify similar aspects of the system of the subject invention, there is illustrated in FIG. 1 a schematic representation of the core functional components of the computer-based portfolio reporting system of the subject invention, which is designated generally by reference numeral 10. Reporting system 10 is adapted and configured to facilitate the generation of user-defined portfolio reports for fixed income securities. More particularly, the system of the subject invention enables a user, through a graphical interface, to selectively group a portfolio of fixed income securities in real-time based upon specific attributes and/or characteristics associated with the securities. The system is intended for use by, among others, portfolio managers, agents, custodians and investors.

Portfolio reporting system 10 includes a graphical interface 12 that includes input and output devices. Graphical interface 12 is operatively associated with a control program 14 containing an instruction set written in a conventional computing language such as HTML, C++ or Java. Control program 14 coordinates the interactive relationship between the graphical interface 12, a portfolio database 16 and a set of processors 18 which receive data and instructions and function as analytical servers 20 for managing data throughput.

Portfolio database 16 stores a plurality of investment portfolios owned by individual or institutional investors. Each portfolio includes a plurality of investment products in the form of fixed income securities such as U.S. Treasury notes or bonds, municipal, corporate or agency bonds, mortgage-backed securities or derivative instruments.

The analytical servers 20 are preferably web-based and are adapted and configured to analyze securities contained within each portfolio in database 16 based on real-time market data. The analytical servers provide inter-day and intra-day computations and provide flexibility to a portfolio manager to change underlying assumptions. More particularly, the analytical servers are configured to perform real-time analyses on a portfolio of fixed income securities based upon static measures, option-adjusted measures and horizon analysis using different variables including, for example, real-time yield curves, prepayment models, volatility and curve shocks. Once a portfolio has been analyzed using the analytical servers 20, the system 10 of the subject invention allows a portfolio manger to define, in real-time, the format of a report in a manner that highlights the results of the analysis.

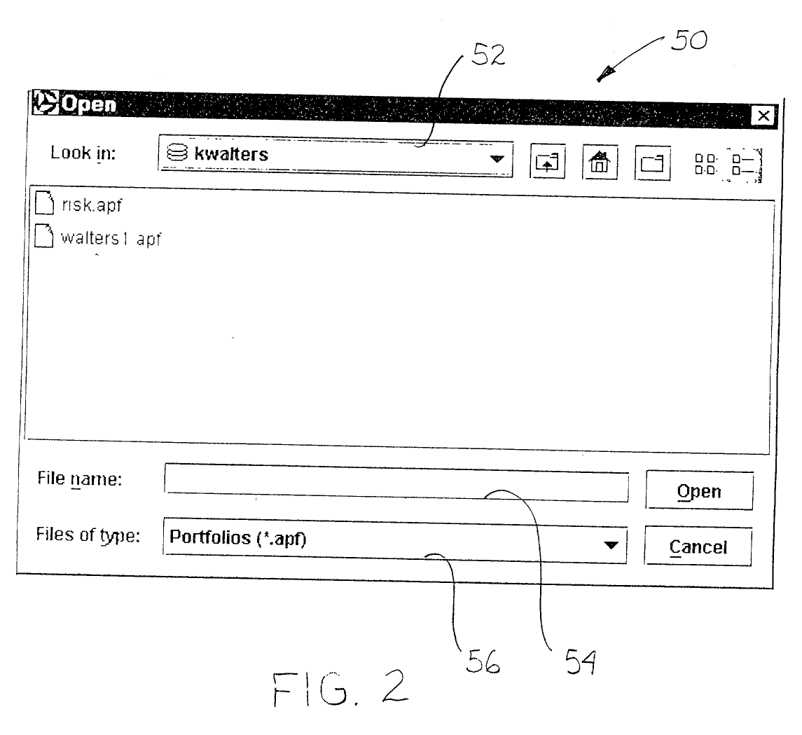

Referring to FIG. 2, there is illustrated a display screen defining the graphical user interface 50 with which a portfolio manger or other interested party selects a portfolio of financial instruments from portfolio database 16. Using graphical interface 50, a portfolio manger can look in a specific database location for a portfolio or for a group of related portfolios (e.g., kwalters) by specifying the database location in data entry field 52. In addition, using the graphical interface 50, a portfolio manager can enter a specific file name (e.g., walters1.apf) or search for types of files by specifying an appropriate file extension (e.g., (*.apf)) in data entry field 54 and 56, respectively.

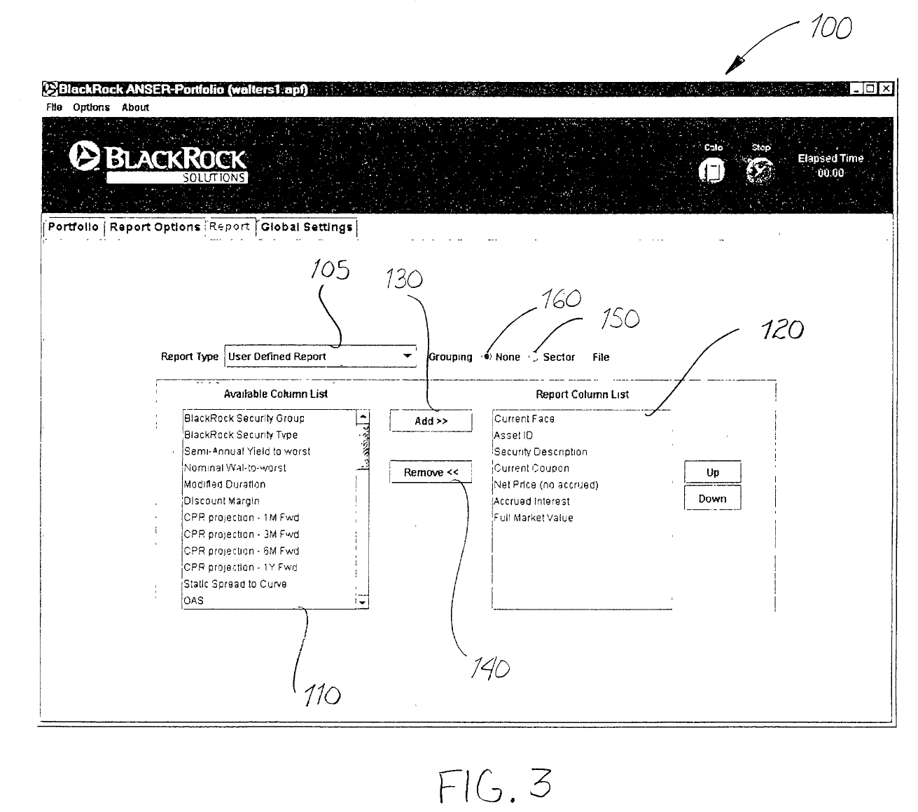

Referring to FIG. 3, there is illustrated a display screen defining the graphical user interface 100 with which a portfolio manger or other interested party selectively creates the format of a user-defined portfolio report, or alternatively can select a stored pre-formatted portfolio report by specifying a particular type of report in data entry field 105. As illustrated, interface 100 has two main windows including an “Available Column List” in window 110 on the left side of the screen and a “Report Column List” 120 on the right side of the screen. The “Available Column List” in window 110 contains a list of the attributes associated with fixed income securities for which columns can be generated in a user-defined portfolio report.

The identification information includes security description (e.g., FGOLD 30YR TBA) and Asset ID (e.g., FG0600300), as well as financial information including static measures such as, for example, current face value, current coupon, net price, market price, full market value, nominal yield, static spread to curve, accrued interest, modified duration, discount margin, prepayment duration, and option-adjusted measures such as, for example, option-adjusted spread (OAS), option-adjusted duration (OAD), option-adjusted convexity (OAC). In general, these attributes correspond to the analytics provided by the analytical server with which the reporting system 10 of the subject invention is operatively associated. It is envisioned that the “Available Column List” in window 110 is dynamic and can be edited to add new attributes in coordination with the analytical server.

The “Report Column List” 120 includes the attributes selected by a portfolio manager. This subset of attributes is used to define the columns of the user-defined report for a particular portfolio of fixed income securities. Using the graphical interface 100, a portfolio manger can select an attribute in window 110 using a conventional data entry device, and click on the “Add” button 130 to transfer the selected attribute to window 120. Conversely, a portfolio manger can select an attribute in window 120 using a conventional data entry device, and click on the “Remove” button 140 to transfer a selected attribute back to window 110.

With continuing reference to FIG. 3, the graphical user interface 100 provides the portfolio manger or other interested party with the capability to format a portfolio report such that fixed income securities within a portfolio are grouped based upon a selected characteristic, such as the asset class or asset sector with which they are associated (e.g., Treasury bonds, derivatives, mortgages). If grouping by sector is preferred, the user selectively clicks on the “Sector” button 150 with a data entry device, and if grouping is not-preferred, the user selectively clicks on the “None” button 160. While not illustrated in FIG. 3, it is envisioned and well within the scope of the subject disclosure that a user can group securities by selecting from a menu of asset-based or risk-based characteristics.

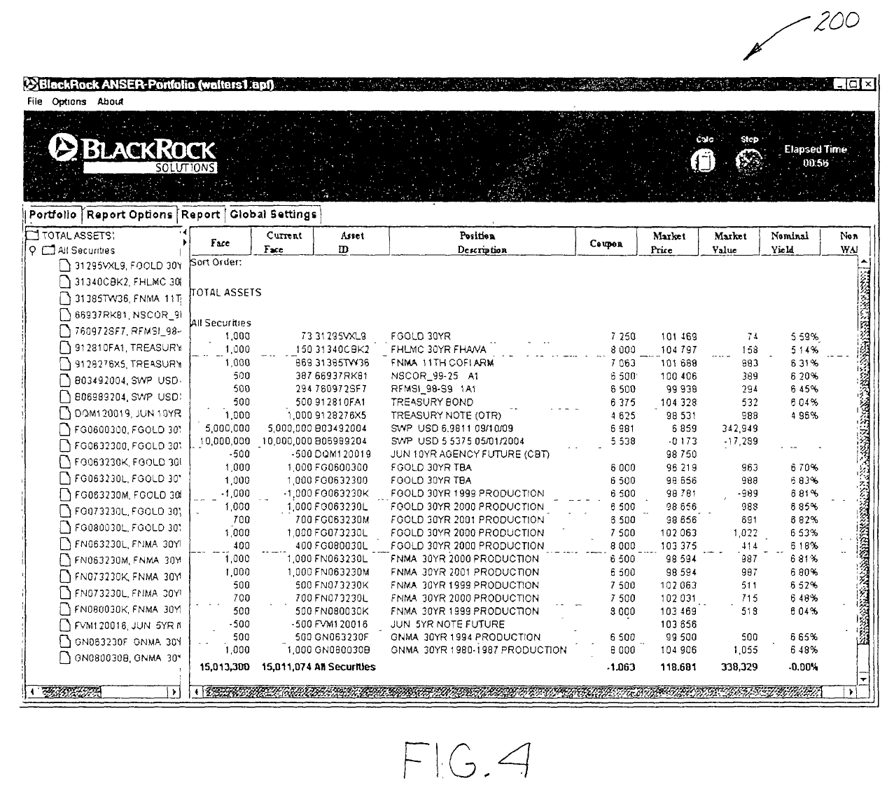

Referring to FIG. 4, there is illustrated a display screen presenting an exemplary portfolio report 200 for a portfolio of fixed income securities designated “walter1.apf” which contains a plurality of securities having a total asset value of $15,013,300. As illustrated, portfolio report 200 is in an ungrouped format in that the securities contained therein are not grouped based upon any specific characteristic, such as respective asset class or sector. The selected attributes used for the column headings of portfolio report 200 include, among others, Face, Current Face, Asset ID, Position Description, Coupon, Market Price, Market Value, and Nominal Yield.

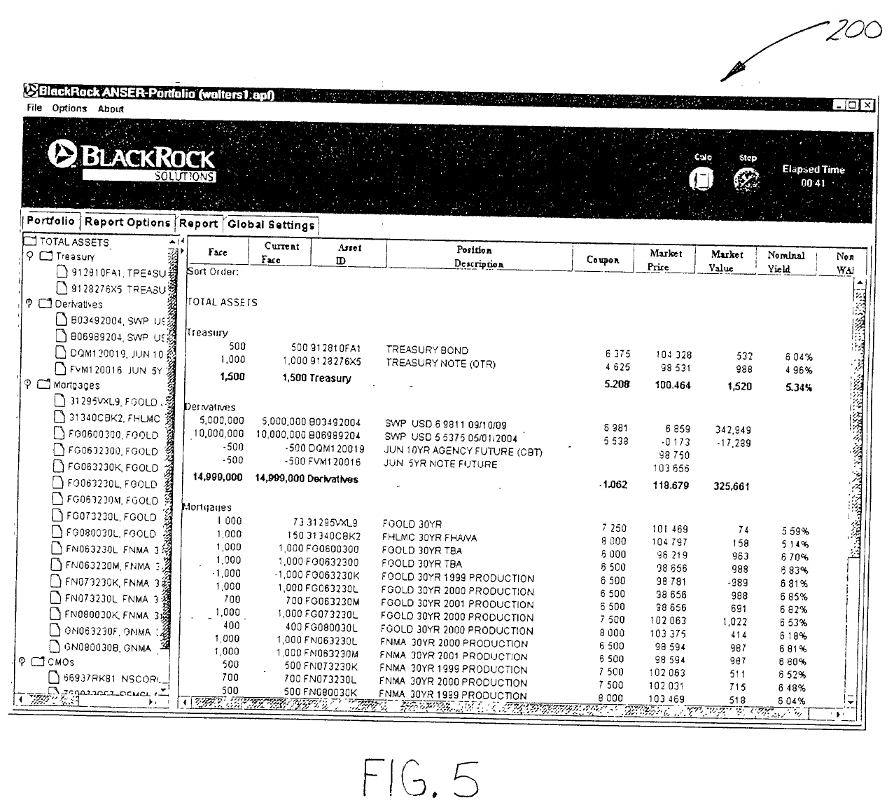

Referring now to FIG. 5, there is illustrated a display screen presenting portfolio report 200 in a grouped format wherein the fixed income securities contained therein are grouped according to their respective asset class or sector. More particularly, portfolio report 200 has been sectored into four groupings, namely, Treasuries, Derivatives, Mortgages and CMO's. Each grouped sector of securities is provided with a sub-total for each of the selected attributes or columns in the report. Furthermore, the securities within each sector are sorted by a specific attribute, preferably, by the position description. For example, in the Derivatives sector, the swaps and futures are sorted and grouped together within the sector.

Although the system and method of the subject invention have been described with respect to preferred embodiments, those skilled in the art will readily appreciate that changes and modifications may be made thereto without departing from the spirit and scope of the subject invention as defined by the appended claims. For example, while the subject invention has been described with respect to a system and method which groups securities in a portfolio based upon asset sector, it should be readily apparent that the securities in a portfolio can be grouped based upon other characteristics including other asset-based characteristics, as well as risk-based characteristics.

What is claimed is:

1. A system for formatting a computer generated report for a portfolio of fixed income securities comprising:
a) means for selecting a portfolio of fixed income securities stored in a portfolio database, each fixed income security in the portfolio having a set of attributes associated therewith;
b) means for selecting a subset of attributes from the set of attributes for presentation in a report for the selected portfolio of fixed income securities; and
c) means for grouping the fixed income securities in the selected portfolio for presentation in the report.

2. A system as recited in claim 1, each fixed income security in the portfolio belongs to an asset sector.

3. A system as recited in claim 2, wherein the means for grouping the fixed income securities in the selected portfolio is adapted to group the securities according to asset sector.

4. A system as recited in claim 1, wherein the portfolio database contains a plurality of portfolios of fixed income securities.

5. A system for formatting a computer generated report for a portfolio of fixed income securities comprising:
a) means for selecting a portfolio of fixed income securities stored in a portfolio database, each fixed income security in the portfolio belonging to an asset sector and having a set of attributes associated therewith;
b) means for selecting a subset of attributes from the set of attributes for presentation in a report for the selected portfolio of fixed income securities; and
c) means for grouping the fixed income securities in the selected portfolio according to asset sector for presentation in the report.

6. A system as recited in claim 5, wherein the means for selecting a subset of attributes includes a graphical user interface presenting a list of available attributes.

7. A system as recited in claim 6, wherein the means for selecting a subset of attributes includes means for selectively adding attributes to and removing attributes from the subset of attributes.

8. A system as recited in claim 5, wherein the fixed income securities in each asset sector are sorted for presentation based upon a particular attribute from the subset.

9. A system as recited in claim 8, wherein an attribute associated with each fixed income security in the portfolio is a security description, and wherein the fixed income securities in each asset sector are sorted for presentation based upon the security description for each fixed income security.

10. A system as recited in claim 5, wherein the portfolio database contains a plurality of portfolios of fixed income securities.

11. A system for formatting a computer generated report for a portfolio of fixed income securities comprising:
a) a portfolio database storing a plurality of portfolios, each portfolio containing a plurality of fixed income securities, each fixed income security belonging to an asset sector and having a set of attributes associated therewith; and
b) a graphical user interface operatively associated with the portfolio database and including:
i) means for selecting a portfolio of fixed income securities stored in the portfolio database;
ii) means for selecting a subset of attributes from the set of attributes for presentation in a report for a selected portfolio of fixed income securities; and
iii) means for grouping the fixed income securities in a selected portfolio according to asset sector for presentation in the report.

12. A system as recited in claim 11, wherein the graphical user interface includes a list of available attributes.

13. A system as recited in claim 11, wherein the means for selecting a subset of attributes includes means for selectively adding attributes to and removing attributes from the subset of attributes.

14. A system as recited in claim 11, wherein the fixed income securities in each asset sector are sorted for presentation based upon a particular attribute from the subset.

15. A system as recited in claim 14, wherein an attribute associated with each fixed income security in the portfolio is a security description, and wherein the fixed income securities in each asset sector are sorted for presentation based upon the security description for each fixed income security.

16. A method of formatting a computer generated report for a portfolio of fixed income securities comprising the steps of:
a) selecting a portfolio of fixed income securities stored in a portfolio database, each fixed income security in the portfolio having a set of attributes associated therewith; and
b) selecting a subset of attributes from the set of attributes for presentation in a report for the selected portfolio of fixed income securities.

17. A method according to claim 16, wherein each fixed income security in the portfolio belongs to an asset sector and the method further comprises the step of selectively grouping the fixed income securities in the selected portfolio according to asset sector for presentation in the report.

18. A method according to claim 16, wherein the step of selecting a subset of attributes includes the step of selectively adding attributes to and removing attributes from the subset of attributes.

19. A method according to claim 16, further comprising the step of generating a report for the selected portfolio of fixed income securities based upon the selected subset of attributes.

20. A method according to claim 19, further comprising the step of generating a report for the selected portfolio of fixed income securities based upon asset sector.
